(19) United States
(12) Patent Application Publication
(10) Pub. No.: US 2025/0238529 A1
(43) Pub. Date: Jul. 24, 2025

(54) METHOD FOR ENCRYPTING A SOURCE CODE, METHOD FOR DECRYPTING A SOURCE CODE AND DEVELOPMENT SYSTEM

(71) Applicant: Beckhoff Automation GmbH, Verl (DE)

(72) Inventor: Ralf Dreesen, Rietberg (DE)

(21) Appl. No.: 19/175,752

(22) Filed: Apr. 10, 2025

Related U.S. Application Data
(63) Continuation of application No. PCT/EP2023/082728, filed on Nov. 22, 2023.

(30) Foreign Application Priority Data
Nov. 25, 2022 (DE) 10 2022 131 254.2

(51) Int. Cl. G06F 21/60; G06F 8/77

(52) U.S. Cl. CPC G06F 21/602; G06F 8/77

(57) ABSTRACT

A method for encrypting a source code for use in a version control system, is provided including providing the source code in an unencrypted and textual form in a provisioning step, carrying out an encryption of the source code and generating an encrypted source code version in an encrypting step, and carrying out a textualization of the encrypted source code version and generating a textualized representation of the encrypted source code version in a textualizing step. A method for decrypting an encrypted source code version is also provided, along with development system for carrying out the methods.

### CROSS-REFERENCE TO RELATED APPLICATIONS

This patent application is a continuation of International Patent Application PCT/EP2023/082728, filed Nov. 22, 2023, “Method for Encrypting a Source Text, Method for Decrypting a Source Text, and Development System,” which claims the priority of German patent application DE 2022 131 254.2, filed 25 Nov. 2022, “Verfahren zum Verschlüsseln eines Quelltextes, Verfahren zum Entschlüsseln eines Quelltextes und Entwicklungssystem,” each of which is hereby incorporated by reference, in the entirety and for all purposes.

### FIELD

The invention relates to a method for encrypting a source code for use in a version control system, a method for decrypting a correspondingly encrypted source code and a development system which is set up to carry out the two methods.

### BACKGROUND

Programmable logic controllers (PLCs) are predominantly used to control and regulate machines and systems, particularly in the automation sector. The control or regulation behavior is expressed by correspondingly set up control programs that may be executed on the respective PLC. Such control programs are usually developed individually by a developer for the respective machine or system type.

Version control systems are known from the state of the art for the development of source code. Such version control systems make it possible to store and manage different versions of the source code to be developed in order to structure the development process of the source code and to enable the developer or developers to access older versions of the source code during the development process.

In addition to managing the versions of the source code created during a development process, the version control systems known from the state of the art make it possible to identify changes that have been made between different versions of the source code.

For this purpose, the different versions of the source code are stored in the memory area of the version control system and must be available in text form so that changes made by the version control system may be detected and identified.

However, if source texts are developed by a number of developers or if the version control systems may generally be viewed by a number of people, for example because the version control systems are operated on a publicly or at least partially publicly accessible server system, there is a risk that unauthorized persons will gain access to the developed source texts and thus unintentionally disclose company secrets. Particularly in the field of automation, the source texts of control programs for controlling automation systems must be protected against access by third parties.

### SUMMARY

Therefore, the application provides an improved method for encrypting a source code for use in a version control system, an improved method for decrypting an encrypted source code and a development system for carrying out the methods.

### EXAMPLES

According to an aspect of the application, a method of encrypting a source code for use in a version control system is provided, said method comprising:
providing the source code in an unencrypted and textual form in a provisioning step;
carrying out an encryption of the source code and generating an encrypted source code version in and encrypting step; and
carrying out a textualization of the encrypted source code version and generate a textualized representation of the encrypted source code version in a textualizing step.

This may have the technical advantage of providing an improved method for encrypting source code for use in a version control system.

For this purpose, the developed source code is first encrypted and an encrypted source code version is generated. The encrypted source code version may be encrypted using encryption methods known from the state of the art.

A textualized representation of the encrypted source code version is then generated. For this purpose, a textualization of the encrypted source code version is carried out. This may be achieved, for example, by textualizing methods known from the prior art.

The textualized representation of the encrypted source code version allows the encrypted source code version to be managed in the form of the textualized representation in a version control system.

Version control systems known from the state of the art are used to manage development processes when developing source code. The version control systems known from the state of the art are designed in such a way that, in addition to management, the version control systems may register and, as the case may be, display changes made between different versions of the developed source code. For this purpose, however, the source code uploaded to the version control system must be available in a textualized representation. The version control systems known from the prior art are only able to work on textualized files and, based on the textualized form of the available source code files, to register the changes made between different versions of the uploaded source code and, as the case may be, to display them.

By textualizing the encrypted source code version, the source code version may be managed in encrypted form by a version control system known from the state of the art. Changes in the various versions of the developed source code may be registered and displayed by the version control system on the basis of the textual representation.

By encrypting the source code as described above, it is possible to prevent unauthorized persons from gaining access to the developed source code during the administration of the developed source code versions, thereby possibly revealing company secrets. According to the application, the encryption of the source code is embodied in such a way that different versions of the developed source code lead to different encrypted source code versions.

The differences between the various source code versions may therefore be viewed in the various encrypted source code versions. Through textualizing, the version control system may thus register the different encrypted source code versions and, as the case may be, the respective differences in the encrypted source code versions without disclosing the actual generated source code.

The version control system may therefore only register different encrypted source code versions in the form of the different encryptions and, as the case may be, display the different locations within the source code. However, the actual source code is never open in the version control system due to the encryption.

This allows for increased data security and prevents the unintentional disclosure of the generated source code. At the same time, the textualized representation of the encrypted source code versions ensures the management of the various source code versions during the development process in control systems provided for this purpose and known from the state of the art. This simplifies and accelerates the development process.

In the context of automation applications, it may be necessary to protect a programmed source code, especially for control programs for automation systems, from unauthorized access.

This may be relevant in the following potential use case, for example. A source code, for example for a control program for an automation system, is developed by a developer of a company, for example using a version control system, and stored on a control system of another company so that the developer may access the programmed source code at a later time, for example to correct errors.

The owner company of the source code may have the motivation to protect the source code, which may include a company secret, from being viewed by unauthorized persons, for example by employees of further company acting as a competitor to the first company.

The method according to the application allows the owner company to protect the generated source code and the company secrets contained therein by encrypting the source code. The encryption is carried out in such a way that the encrypted source code may be managed in version control systems known from the prior art, or that debugging processes may be executed based on the encrypted source code in order to be able to check the functionality of the source code.

In a further application of the method according to the application, a developer of a company stores source code created, for example using a version control system, on a system, for example a server, of the company.

The method according to the application may prevent access to the developed source code by a further developer from another company. A further developer of the other company, on the other hand, should have access to at least a certain part of the source code, but possibly not to other parts of the source code, since, for example, company secrets are disclosed in this part.

Using the method according to the application, individual parts of a source code may be encrypted in such a way that individual persons may be granted partial access to the source code, while other parts of the source code may still be kept inaccessible.

According to an embodiment, the encryption and/or textualization takes place line by line, wherein a line order of the unencrypted source text is retained in the encrypted source text version and/or in the textualized representation of the encrypted source text version.

This has the technical advantage that the line-by-line encryption and the line-by-line textualization of the encrypted lines of the encrypted source code version retain the line structure of the original source code. By retaining the line structure, the version control system may display individual lines that have been changed between different source code versions based on the textualized representation of the encrypted source code version. This may further improve the development process by immediately showing the changes made between different source code versions by registering or displaying the changes made between the different source code versions line by line.

The line order describes the arrangement of the individual lines within the source text, within the encrypted source text version or within the textualized representation of the encrypted source text version.

This means that an nth line within the unencrypted source text leads to an nth encrypted line within the encrypted source text version and to an nth textualized line representation of the nth encrypted line within the textualized representation. An encrypted line within the encrypted source text version with a specific line number thus corresponds to an encryption of the line within the unencrypted source text with the same line number. The same applies to the respective line within the textualized representation, which is also based on the corresponding encrypted line of the encrypted source text version with the same line number.

According to an embodiment, the method further comprises:
carrying out a line separation of the source text and generate separated lines of the source text in a line separating step;
wherein the encrypting step is carried out on the separated lines of the source text and includes for each separated line; and
carrying out an encryption of a line and generating an encrypted line of the encrypted source code version in a line encrypting step.

This has the technical advantage that the individual lines of the unencrypted source text may be encrypted line by line. By separating the individual lines of the unencrypted source text and the corresponding generation of a plurality of separated lines, the line-by-line application of the encryption to the individual separated lines of the unencrypted source text and the corresponding line-by-line generation of corresponding encrypted lines of the encrypted source text version enables the creation of a plurality of individually encrypted lines. The encrypted source text version describes the majority of the encrypted lines generated in this way.

By separating the individual lines of the unencrypted source text, the line order of the unencrypted source text may be retained. For example, the individual separated lines may be assigned corresponding line numbers that reflect the respective line numbers within the unencrypted source text.

As an alternative, the correspondingly separated lines may be arranged in an order corresponding to the line order of the unencrypted source text in order to be able to maintain the line order during the encryption process. The encrypted lines may also be provided with a corresponding line number or, after encryption, arranged in the corresponding order of the separated lines of the unencrypted source text. This in turn allows for the line order to be retained within the plurality of encrypted lines.

After executing, the textualizing step is carried out on the encrypted lines of the encrypted source code version and includes for each encrypted line:
carrying out a textualization of the encrypted line of the encrypted source code version and generating a textualized line representation of the encrypted line of the encrypted source code version in a line textualizing step.

This has the technical advantage that it is possible to achieve a unique line-by-line textualizing of the plurality of encrypted lines of the encrypted source text version. Textualizing is applied individually to the plurality of encrypted lines of the encrypted source text version. The respective line order, in the form of the line number of the individual encrypted lines or the respective arrangement of the plurality of encrypted lines, may also be retained by carrying out the textualization line by line on the various encrypted lines.

The corresponding textualized line representations, which are textualized representations of individual encrypted lines, may also be provided with corresponding line numbers or arranged according to the corresponding arrangement of the encrypted lines.

According to an embodiment, the textualizing step further comprises:
merging the plurality of textualized line representations of the encrypted lines of the encrypted source code version and generating the textual representation of the encrypted source code version as a whole of the textualized line representation in a line merging step.

This has the technical advantage that a coherent textualized representation of the encrypted source code version may be provided. For this purpose, the plurality of updated line representations previously generated in line-by-line textualization of the plurality of encrypted lines is merged into a corresponding textualized representation of the encrypted source code version.

The textualized representation of the encrypted source text version describes the corresponding summary of the plurality of textualized line representations, wherein the respective line order of the original unencrypted source text is retained in the summary or merging of the plurality of textualized line representations.

For this purpose, the nth textualized line representation, which is based on the nth encrypted line and thus on the nth line of the unencrypted source text, is arranged at the nth position within the textualized representation of the encrypted source text version. The textualized representation of the encrypted source text version generated in this way thus corresponds to a textualized representation of the original source text in which the respective line structure or line order of the original source text is retained, and in which each textualized line representation is a textualized representation of an encrypted line which is based on the respective original line of the unencrypted source text.

The textualized representation of the encrypted source code version thus looks to the version control system like a standard source code consisting of n lines, each of which contains text elements. Despite the textualized representation, however, the content of the source code is encrypted and may therefore not be read by unauthorized persons without carrying out the respective key.

According to an embodiment, the encryption is embodied as a decryptable encryption, wherein by applying a corresponding key to the encrypted source code version, the encrypted source code version may be clearly traced back to the unencrypted source code version.

This may achieve the technical advantage that the encrypted source code version may be traced back to the original source code by carrying out a corresponding decryption, so that, for example, when downloading the textualized representation of the encrypted source code version from the version control system, the original source code may be restored by a corresponding decryption, so that a corresponding user or developer may continue the development process based on the respective source code.

The primary purpose of encrypting the original source code is therefore to protect the source code from being viewed by unauthorized persons when it is managed within the version control system. However, the source code may be restored by authorized persons who are in possession of the respective key through the corresponding decryption, so that further processing of the original source code is possible.

According to an embodiment, the encryption is embodied as a symmetric encryption.

This has the technical advantage that symmetric encryption may be used to provide the simplest possible encryption.

According to an embodiment, the encryption is embodied as an asymmetric encryption.

This has the technical advantage that asymmetric encryption may provide the most secure encryption of the source text possible.

According to an embodiment, the textualization is embodied as a clearly reversible textualization, wherein the textualized representation of the encrypted source text version may be clearly converted into the encrypted source text version by reversing the textualization in the form of a de-textualization.

This may achieve the technical advantage that the reversible textualization allows the textualizing of the textualized representation of the encrypted source text version to be reversed and the encrypted source text version to be restored from the textualized representation of the encrypted source text version.

This also allows for decrypting the encrypted source code version by applying the corresponding key. In order to restore the original source code from the textualized representation of the encrypted source code version, the textualization of the textualized representation of the encrypted source code version is first reversed and the encrypted source code version is restored from the textualized representation of the encrypted source code version.

The corresponding key is subsequently executed on the encrypted source code version and the original source code is generated by decrypting the encrypted source code version. Since both the textualization and the encryption are clearly reversible, the original source text may be restored in an unambiguous manner using the decrypting process described.

On the one hand, this allows for secure management of source code within a version control system. On the other hand, the original source code managed by the decryption described above may be restored in the form of the textualized representation of the encrypted source code version in the version control system in order to be able to process it further if necessary.

According to an embodiment, the encryption is a unique encryption which results in the same encrypted lines for lines of the source text with the same content and in different encrypted lines for lines of the source text with different content, and/or wherein the textualization is a unique textualization which results in the same textual line representation for encrypted lines with the same encryption and in different textual line representations of the encrypted lines for encrypted lines with different encryption.

This may achieve the technical advantage that the unique encryption or unique textualization, in which different lines of the original source code with the same content lead to the same encrypted lines of the encrypted source code version or the same textualized line representations, while lines of the original source code with different content lead to different encrypted lines and different textualized line representations, may achieve a unique decryption of the textualized representation of the encrypted source code version and a unique restoration of the original source code. This allows for problem-free further processing of the various source texts managed in form of the textualized representations of the encrypted source code versions in the version control system.

According to an embodiment, the encryption is embodied as a binary encryption.

This achieves the technical advantage that a technically simple and secure encryption may be provided.

After an execution, the textualization of the encrypted source code version is achieved by the textualization algorithm base64.

This achieves the technical advantage of enabling a clear and precise textualization of the encrypted source code version.

After execution, the source code defines a control program for an automation system.

This may achieve the technical advantage that the method according to the application allows for secure management of control programs in version control systems, in which unauthorized persons may view the source code of the control programs and any unintentional disclosure of company secrets contained in the control programs may be avoided.

According to a further aspect of the application, a method for decrypting a source code encrypted according to the method for encrypting a source code according to one of the preceding embodiments is provided, comprising:
carrying out a line separation of the textualized representation of the encrypted source code version and generating separated textualized line representations of the encrypted lines of the encrypted source code version in a further line separating step;
executing a de-textualization of each textualized line representation of the encrypted lines of the encrypted source code version in a de-textualizing step;
carrying out a decryption of the encrypted lines of the encrypted source code version and generating unencrypted lines of the source code in a decrypting step; and
merging the unencrypted lines of the source text and generate a visible representation of the source text in a further line merging step.

This may achieve the technical advantage of providing an improved method for decrypting source code that has been encrypted using the method for encrypting source code according to any one of the preceding embodiments. The decryption allows for further processing of the encrypted source code, for example by a developer for further development of the source code. Due to the uniqueness of the encryption/decryption, the original unencrypted source code may be restored.

According to a further aspect of the application, a development system for developing and/or editing a source code is provided, wherein the development system is arranged to carry out the method for encrypting a source code for use in a version control system according to one of the preceding embodiments and/or the method for decrypting a source code.

This may achieve the technical advantage that an improved development system may be provided which is set up to carry out the methods according to the application for encrypting and/or decrypting source texts with the stated technical advantages.

### BRIEF DESCRIPTION OF THE DRAWINGS

The application is described in more detail with reference to the attached figures, in which:

FIG. 1 is a graphical depiction of a method for encrypting a source code for use in a version control system according to an embodiment;

FIG. 2 shows a graphical depiction of a method for decrypting a source text according to an embodiment;

FIG. 3 shows a flowchart of the method of encrypting a source code for use in a version control system according to an embodiment;

FIG. 4 shows a further flowchart of the method of encrypting a source code for use in a version control system according to a further embodiment; and

FIG. 5 shows a flowchart of a method for decrypting a source code according to an embodiment.

### DETAILED DESCRIPTION

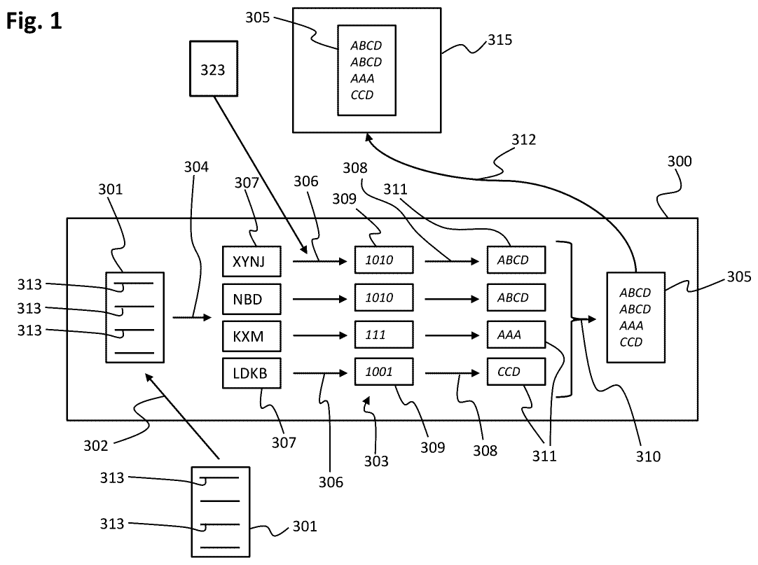

FIG. 1 shows a graphical depiction of a method 100 for encrypting a source code 301 for use in a version control system 315 according to an embodiment.

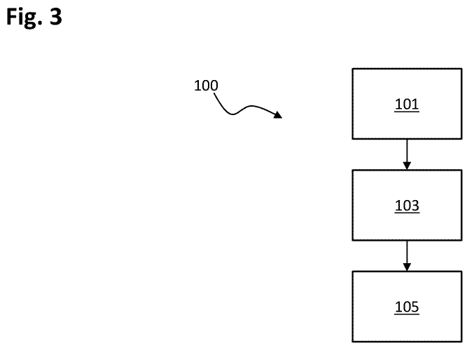

In the graphical representation of FIG. 1, individual steps of the method according to the application for encrypting a source code 301 in a version control system 315 described with respect to FIG. 3 are described.

FIG. 1 shows a development system 300 for developing source codes 301 and a version control system 315 for storing and managing different versions of the developed source codes 301. The development system 300 as well as the version control system 315 may be embodied as development systems 300 or version control systems 315 known from the prior art.

In particular, the development system and the version control system may also be identical and located on the same computing unit.

For the purposes of the application, a development system 300 is a development environment for developing source code. Such a development system 300 may be provided, for example, by an IDE (intelligent development engine).

A development system 300 as used in automation technology for example, provides a developer of automation software with various functions for programming such software. In the case of text-based programming languages as set forth in DIN 61131, these include, for example, the auto-completion of frequently used programming expressions or similar. In the case of graphical programming languages as set forth in DIN 61131, the development system provides the graphical representation of this programming.

A development system may therefore be used by developers of software products to develop control programs for machines or automation systems and other technical systems.

Developers may use different programming languages for this purpose. In the automation sector, programming languages as set forth in DIN 61131 are primarily used. These may also include graphical programming languages.

Development systems may also be used by developers to observe and understand the behavior of programmed control programs during execution, for example to analyze errors or optimize behavior. This is achieved in debugging processes.

Development systems may also be used by technicians to put an installation into operation, for example an automation system. This may include transferring a control program to a corresponding controller, for example a PLC-programmable logic controller, and setting system parameters or observing the system behavior as described above in order to rule out or detect installation errors.

Development systems may also be used by operators of a technical system, for example an automation system, to control the system, operate it manually, bypass behavior or set simple parameters.

In automation, a control program is usually formulated in one or more of the languages of the IEC 61131-3 standard.

The standard comprises five languages: “Structured text”, “Instruction list”, “Sequential function chart”, “Ladder diagram” and “Function block language”. “Structured text” and “Instruction list” are textual languages. “Ladder diagram” and “Function block language” are graphical languages. “Ladder Diagram” includes both textual and graphical aspects.

The input of source text during programming may be supported by auto-completion mechanisms within the development system used. Auto-completion may, for example, complete the input of a keyword, correct it and/or insert another associated keyword.

Input may also be made easier by displaying information. For example, expected parameters of a function call may be displayed.

If program code is detected as faulty (during input), the corresponding point within the source code may be highlighted and an optional explanation may be displayed, making it easier to rectify errors immediately.

A version control system 315 may be embodied as a public version control system, for example the commercially available GitHub service, which uses the open-source version control system software GIT.

Alternatively, the version control system 315 may be embodied as a private version control system that is operated on a company-internal server architecture.

A version control system provides a management tool for the development process of software products. During the development process of a software product, for example a control program for an automation system, newly created versions of the written source code may be stored in the version control system and managed by it. During the development process in which new versions of the source code are continuously created, the user may thus track the development process and in particular the progress by managing the versions of the source code stored in the version control system. The version control system offers the user numerous different functions for this purpose. For example, the user may be provided with a line-by-line structured change log in which the changes made between the different versions of the source code are displayed line by line. This makes it possible to compare different versions of a source code created at different times or by different developers.

For example, the change log may include information on which lines have been changed in which way between different versions. For example, reference may be made to newly added lines, deleted lines and changed lines.

Usually, users of a version control system may store the versions of the source code as a set of files, which are usually embodied as text files and contain program code, in a directory structure of the version control system.

The version control system then allows the user to access not only one state of this data, but a number of such states. The version control system associates additional information with a state, which may include, for example, the creation date, the creator, an informal description, a unique number and a reference to a previous state.

Version control systems are usually set up in such a way that a complete state is not saved, but only current changes to a current version in relation to a version of the source code that describes a previous state of the source code. This makes it possible to save resources, as successive versions build on each other and generally only differ slightly.

Based on this information, the version control system may provide the user with the data of any version of the source code (check-out). The user may therefore take any older versions into account and include them in the development process, as the case may be.

The version control system may also show the user which files differ between two versions or only exist in one version.

If these are text files, the version control system may also show which lines are different or only exist in one version (diff).

The version control system may also show the user for each line of a text file in which (previous) version this line was last changed or inserted. For example, the date, the author and part of the description may be displayed next to each line (blame).

The version control system may also merge versions that were developed independently of each other, for example by different developers.

The version control system may also undo (revert) changes between two successive versions, even if only partially.

The version control system may also reorganize and modify version sequences as change sequences (re-base).

The version control system may also apply changes as a difference between two versions of the source code to another version of the source code (cherry-pick).

In order to carry out the encryption of a source code 301, the development system 300 first provides a source code 301 having a plurality of lines 313 in a provisioning process 302. The provisioning may here be carried out in a development process in which the source code 301 was created by a developer within the development system 300 by carrying out a corresponding programming process.

As an alternative or in addition, the deployment process 302 may comprise reading in an already created source code 301 by the development system 300.

In a line separation process 304, the development system 300 generates a plurality of separated lines 307 from the provided source text 301. The individual separated lines 307 correspond in content to the respective lines 313 of the provided source code 301. The separated lines 307 thus differ from the lines 313 of the original source code 301 only in that they are provided as independent lines, or as independent objects, and are not combined in an entire document in the form of the original source code 301.

The separated lines 307 may be saved as separate files.

The line separation process 304 preferably retains the line order of the lines 313 of the original source text 301. An nth line 313 thus becomes an nth separated line 307. The nth separated line 307 is thus arranged at the nth position within the totality of the plurality of n-separated lines 307. For this purpose, the individual separated lines 307 may be assigned a corresponding line number, which corresponds to the line number of the respective line 313 within the original source text 301.

The character combinations within the separated lines 307 should represent the source code programmed within each line.

As an alternative or in addition, the respective separated line 307 may be arranged within the plurality of separated lines 307 at the respective nth position, wherein the respective arrangement position of the respective separated line 307 reflects the line number of the corresponding line 313 of the original source text 301 from which the separated line 307 originated.

In an encryption process 306, the individual separated lines 307 are then encrypted line by line and corresponding encrypted lines 309 are generated. The separated lines 307 are each taken into account as individual encryption objects, and the corresponding encryption is applied line by line, i.e. separated, to the individual separated lines 307.

The encryption process 306 is used to encrypt the separated lines 307 using a first key 323.

Two separated lines 307 with the same content therefore lead to lines 309 with the same encrypted content.

Due to the line-by-line encryption in the encryption process 306 and the corresponding line-by-line generation of the encrypted lines 309, the line order of the separated lines 307, which reflects the line order of the original lines 313 of the unencrypted source text 301, is retained. For this purpose, corresponding line numbers may be added to the encrypted lines 309, which correspond to the respective line numbers of the original lines 313 within the source text 301.

Alternatively, the corresponding encrypted lines 309 may be arranged according to the line order of the lines 313 of the original source code 301 such that the nth encrypted line 309 representing the nth line 313 of the original source code 301 is arranged at the nth position within the plurality of encrypted lines 309. In this context, the plurality of encrypted lines 309 defines the encrypted source code version 303, which represents the entirety of the encryption of the original source code 301.

The encrypted lines 309 may be cached individually as single objects.

As an alternative or in addition, the encrypted lines 309 may be temporarily stored as partial objects in the encrypted source code version 303 as a complete object.

The encryption may, for example, be in the form of binary encryption. In the illustration shown, the corresponding encrypted lines 309 are shown as binary elements, which is intended to illustrate a corresponding binary encryption.

Examples of binary encryption are RSA encryption (Rivest-Shamir-Adleman) or AES encryption (Advanced Encrypted Standard). Both encryption methods use a key to convert data into a form that may only be traced back to the original data if the key is known. In symmetric encryption, the same key is used for encryption and decryption. In asymmetric encryption, separate and different keys are used for encryption and decryption.

Both methods consider a sequence of bytes as input and return an (encrypted/decrypted) sequence of bytes, where a byte is an integer in the interval [0 . . . 255].

Each text is interpreted as a sequence of bytes and may therefore be encrypted directly. However, the result is a sequence of bytes that usually does not correspond to a valid line of text.

Alternatively, however, any other encryption may be used.

Preferably, the encryption is provided as a unique or injective encryption, in which separated lines 307 with the same content lead to encrypted lines 309 with the same encrypted representation and separated lines 307 with different content lead to encrypted lines 309 with different encrypted representations. The encrypted representation is shown in FIG. 1 by the corresponding binary number sequence.

In a textualizing process 308, a textualization is then carried out line-by-line based on the encrypted lines 309, and corresponding textualized line representations 311 of the encrypted lines 309 are generated.

The textualization is preferably a unique or injective textualization, in which encrypted lines 309 with different encrypted representations result in different textual line representations 311, while encrypted lines 309 with the same encrypted representation result in the same textualized line representations 311.

This is illustrated by the letter combinations of the illustrated textual line representations 311. The textualized line representations 311 comprise the same letter combinations for encoded lines 309, which describe the same sections of the source code.

Separate lines 307 with the same content lead to the same encrypted lines 309 after encryption.

The textualized line representations 311, on the other hand, have different letter combinations for encrypted lines 309 with different encryption representations. The letter combinations of the textualized line representations 311 are merely intended to illustrate the textual form of the textualized line representation 311. However, the letter combinations shown do not describe real textualized line representations 311 but are to be understood merely symbolically.

By carrying the textualizing process 308, the line order of the encoded lines 309, which corresponds to the line order of the separated lines 307, which in turn corresponds to the line order of the lines 313 of the original source text 301, is maintained. For this purpose, the textualized line representations 311 may be identified with corresponding line numbers that correspond to the respective line number of the original line 313 of the source text 301. Alternatively, the textualized line representations 311 may be arranged or stored in a corresponding order that corresponds to the line order of the original source text 301. For this purpose, the textualized line representations 311 may be temporarily stored as independent objects or files.

The textualizing process 308 may be achieved, for example, by carrying out a base64 algorithm.

The base64 algorithm is a method for encoding 8-bit binary data (e.g. executable programs, ZIP files or images) into a character string consisting only of readable, code page-independent ASCII characters. In the base64 algorithm, 24 bits of three consecutive bytes are divided into four parts of six bits each. Each 6-bit part may represent 64 different values, which may be represented by 64 common textual characters (a-z, A-Z, 0-9, + and/).

In a line merging process 310, the textualized line representations 311 are subsequently merged by the development system 300 according to the respective line order in the textualized representation 305 of the encrypted source text version 303. Here, the textualized representation 305 of the encrypted source text version 303 describes a coherent document in text format in which the textualized line representations 311 are combined as individual lines arranged according to the respective order.

The textualized representation 305 thus describes an encrypted representation of the original source text 301 in text format, wherein the respective content of the original source text 301 is present in the textualized representation 305 in encrypted form. The individual lines of the textualized representation 305 thus represent individual lines 313 of the original source text 301, wherein the respective contents of the lines 313 are encrypted within the textual representation 305, but are still present in textual form.

The content of an nth line of the source code 301 is only reflected in the corresponding nth line of the textualized representation 305. Consequently, a change to the nth line of the source code only results in a change to the nth line of the textualized representation 305. This is an essential condition for the encryption to be usable in version control systems.

In a storage process 312, the textual representation 305 of the encrypted source code version 303 is stored in the version control system 315 already mentioned. The version control system 315 may thus manage the textual representation 305 and read it in on the basis of the textual form and compare it with other textual representations 305 of other source code versions and register corresponding matches or changes and display them if necessary. The actual content of the source code 301 cannot be viewed due to the encryption despite the textual form of the textual representation 305 without carrying out a corresponding decryption.

Alternatively, the textual representation may of course also be saved on a hard disk or other storage medium.

The operations described above, including the line separation operation 304, encrypting operation 306, textualizing operation 308, line merging operation 310, and storage operation 312, may be carried out not only for the entire source code 301, but also only for individual portions of the source code 301.

In particular, the operations may only be executed for the lines of source code 301 that have been newly created or modified in a programming operation. In extreme cases, the process may be executed for only one newly created line.

This means that only the newly created lines of source code 301 may be encrypted and loaded into a version control system, for example. This means that the entire source code 301 does not have to be fully encrypted each time a change is made.

Since, according to the application, an encrypted line 309 of the encrypted source code version 303 corresponds exactly to an unencrypted line of the unencrypted source code 301, typical statements of a version control system, such as the scope of changes or also the determination of a line origin for the encrypted lines 309 of the encrypted source code version 303, continue to be valid. The version control system also fully supports the merging of different states (merge/rebase).

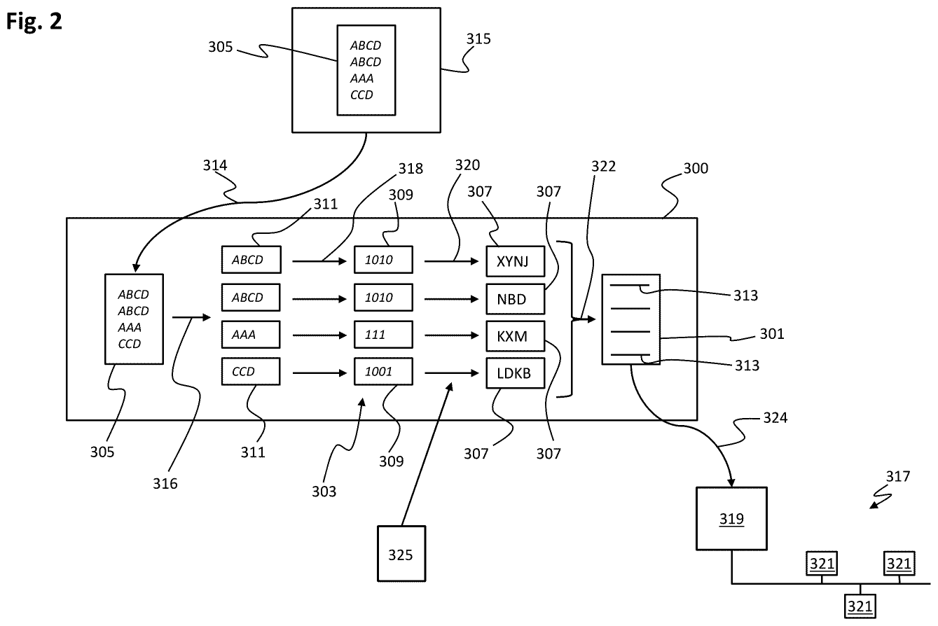

FIG. 2 shows a graphical representation of a method 200 for decrypting an encrypted source code 305 according to an embodiment.

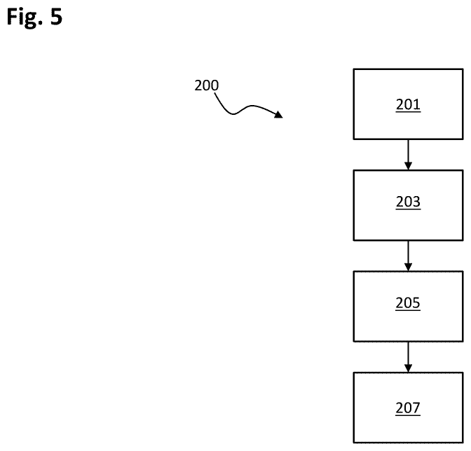

FIG. 2 graphically illustrates individual steps of the method described in FIG. 5 for decrypting encrypted source code. FIG. 2 again shows a development system 300 and a version control system 315, which may be embodied as described in FIG. 1.

In FIG. 2, the textual representation 305 is the same as the textual representation 305 in FIG. 1. Accordingly, the textualized line representations 311 are identical to the textual line representations 311 in FIG. 1. This is merely exemplary in nature and is not intended to limit the method according to the application.

A textual representation 305 of an encrypted source code version 303 of a corresponding source code 301 generated according to the steps described with respect to FIG. 1 is stored in the version control system 315.

In a load operation 314, the textual representation 305 of the encrypted source code version 303 stored and managed in the version control system 315 is loaded into the development system 300.

In a further line separation process 316, the individual lines of the textual representation 305 of the encrypted source text version 303 are separated and corresponding separated textualized line representations 311 are generated based on the description of FIG. 1.

As already described with respect to FIG. 1, the line separation maintains the line order of the individual lines within the textual representation 305 within the textualized line representations 311. For this purpose, the textualized line representations 311 may comprise corresponding line numbers describing the respective arrangement of the respective line within the textual representation 305. As an alternative or in addition, the textualized line representations 311 may be arranged in a corresponding order that describes the line order of the textual representation 305.

In a de-textualizing process 318, the individual textualized line representations 311 are de-textualized line by line and corresponding encrypted lines 309 are generated. The encrypted lines 309 correspond to the encrypted lines 309 on the basis of which the textualized line representations 311 were originally generated by textualization.

The de-textualization in the de-textualizing process 318 thus describes a reverse function to the textualization function that was originally applied to generate the textualized line representations 311 based on the encrypted lines 309 of the encrypted source code version 303.

The textualization is thus preferably embodied as an unambiguous injective textualization function which unambiguously converts encrypted lines 309 into corresponding textualized line representations 311, with the same textualized line representations 311 being generated for encrypted lines 309 with the same encryption representation, while different textualized line representations 311 are generated for encrypted lines 309 with different encryption representations, and wherein the de-textualization generates uniquely corresponding encrypted lines 309 from textualized line representations 311, wherein encrypted lines 309 with the same encryption representation are generated for textualized line representations 311 with the same textual content, while differently encrypted lines 309 are generated for textualized line representations 311 with different textual content.

The encryption representation describes the encrypted form of the content of the respective encrypted line. In the embodiment shown, the encryption representation of an encrypted line 309 is indicated by the respective binary representation shown. The binary representation in this context describes the binary-encrypted content of the respective line 313.

Due to the de-textualization in the de-textualizing process 318, the original line order of the lines within the textualized representation 305 is retained. For this purpose, the correspondingly generated or restored encoded lines 309 may be provided with corresponding line numbers.

Alternatively, the arrangement of the individual encrypted lines 309 may be made according to the line order of the lines within the textual representation 305. The encrypted lines 309 may be stored or cached as individual objects or files.

As an alternative or in addition, a file of the encrypted source code version 303 may be stored or cached, which comprises the entirety of the individual encrypted lines 309.

In a decrypting process 320, the individual encrypted lines 309 are decrypted and corresponding separated lines 307 are generated. The encryption is thus preferably a unique and injective encryption, which makes it possible to achieve a unique decryption of the encrypted lines 309. Due to the line-by-line decryption in the decrypting process 320, the line order of the encrypted lines 309 is retained and the separated lines 307 may be arranged according to the retained line order.

The decrypting process 320 is carried out taking into account a second key 325 for decrypting the encrypted lines 309.

The first key 323 for encryption and the second key 325 for decryption may be embodied as different keys, for example as a private and a public key. Alternatively, the same key may be used for the first and second keys 323, 325.

For this purpose, the individual separated lines 307 may be provided with corresponding line numbers or arranged according to the line order. The decoded separated lines 307 represent the respective lines 313 of the original source text 301 in separated form. The separated lines 307 may be temporarily stored as independent objects or files for this purpose.

In a further line merging process 322, the individual separated lines 307 are merged into the original source text 301. The line order is retained in such a way that the separated lines 307 are merged into the source text 301 according to their line order.

The source code 301 restored in this way may be further processed in the development system 300 in exactly the same way as the original source code 301 that already existed before the encryption or decryption.

The method for encrypting shown in FIG. 1 or the method for decrypting shown in FIG. 2 may be carried out or continued as often as desired during the development process of a source code 301, for example for describing a control program of an automation system. Each time a new version of the source code 301 is generated, for example after completion of a development sub-process, a corresponding textual representation 305 may be generated in accordance with the encryption method described above and loaded into a corresponding version control system 315 and managed there.

For a further continuation of the development process, the textual representation 305 of the previous version of the source code 301, or any older version of the source code 301 managed in the version control system 315, may be decrypted by the decryption procedure described with respect to FIG. 2, and the source code 301 underlying the textual representation 305 may be restored.

As described above, only individual parts of a generated source code 301, for example individual sections or individual lines, may be encrypted according to the method described with respect to FIG. 1 and corresponding textual representations 305 may be generated and managed in a version control system 315. Similarly, individual parts or individual lines may also be decrypted by the decryption method described with respect to FIG. 2 and restored in the original source text form.

This means that the version control system used does not have to manage the complete source code for every change; instead, it is sufficient to primarily manage the newly changed parts of the source code. In particular, developers may only retrieve the parts of the encrypted source code that are of interest to them from the version control system in order to edit them further.

By encrypting the source code 301 line by line, the source code 301 or the encrypted source code version 303 may be divided into any number of small parts, down to individual lines, in order to simplify handling.

FIG. 2 also shows the case where the source code 301 recovered by decryption has been further developed and completed in the development system 300.

It is further shown that the completed source code 301, which for example represents a control program of an automation system 317, is installed on a controller 319 of an automation system 317 in an installation process 324. For this purpose, a corresponding automation system 317 with a controller 319 and a plurality of sensor/actuator units 321 is shown in FIG. 2.

In addition to control programs for automation systems 317, the methods described in FIGS. 1 and 2 for encrypting or decrypting source texts 301 may be applied to any source texts. The methods described for encrypting or decrypting may also be applied to any programming languages.

Preferably, the methods according to the application are applied to programming languages of the DIN 61131 standard.

The method according to the application may particularly be applied to source code 301 that is written in a graphical programming language. For this purpose, the graphical source code of the graphical programming language is stored in a text representation. The method for encrypting or the method for decrypting may be applied to this text representation in accordance with the processes described above for FIGS. 1 and 2.

FIG. 3 shows a flowchart of the method 100 for encrypting a source code 301 for use in a version control system 315 according to an embodiment.

In the embodiment shown, in order to encrypt a source code 301 for use in a version control system 315, a source code 301 is first provided in an unencrypted and textual form in a provisioning step 101. This may e.g. be achieved by a development or programming process or by an installation or loading process of an already programmed source code 301 into a corresponding development system 300.

In an encrypting step 103, encryption of the source code 301 is carried out and an encrypted source code version 303 is generated. The encryption may, for example, be embodied as a binary encryption and the encrypted source text version 303 may represent the unencrypted source text 301 in a binary encryption representation. The encryption may be symmetric or asymmetric.

In an asymmetric method, a key pair may be embodied according to the encryption method, wherein one key may reverse a transformation of the other key. Encryption may therefore be carried out using one key, while the other key is used for decryption.

The keys are embodied in such a way that the other key cannot be derived from one of the two keys.

The two keys are usually referred to as the “public” and “private” key. The public key is available to any communication partner who wants to create an encrypted message. The private key, on the other hand, is private and is used to decrypt the encrypted message.

In particular, the encryption may be embodied in a unique and injective form in which lines 313 of the source code 301 with the same content are encrypted to the same encrypted lines 309, while lines 313 of the source code 301 with different content are encrypted to different encrypted lines 309.

According to an embodiment, the encryption is carried out line by line, in which each line 313 of the source code 301 is encrypted as an independent object and an independent encrypted line 309 of the encrypted source code version 303 is generated accordingly. The encrypted source code version 303 describes the entirety of the individual encrypted lines 309.

In a textualizing step 105, a textualization of the encrypted source code version 303 is carried out and a textualized representation 305 of the encrypted source code version 303 is generated. Here, the textualized representation 305 describes the encrypted source code version 303 in a textual form. The content of the textualized representation 305 remains the encrypted content of the encrypted source code version 303.

According to an embodiment, the textualization is carried out line by line analogous to the encryption and each encrypted line 309 is individually converted into a textualized line representation 311 by the executed textualization.

According to an embodiment, the textualization is embodied as a unique and injective function that generates the same textualized line representations 311 for encrypted lines 309 with the same encryption representation and generates different textualized line representations 311 for encrypted lines 309 with different encryption representations.

According to an embodiment, the textualization may be achieved, for example, by a base64 algorithm.

The line order of the original source text 301 is retained by the encryption and textualization in the textualized representation 305. Accordingly, the textualized line representations 311 of the textualized representation 305 of the encrypted source text version 303 are arranged in the same arrangement or order as the original lines 313 of the originally unencrypted source text 301.

An nth line 313 of the source text 301 thus leads to a textualized line representation 311 of the textualized representation 305 of the encoded source text version 303, which is positioned at the nth position in textualized representation 305. The textualized representation 305 thus describes the entirety of the textualized line representations 311.

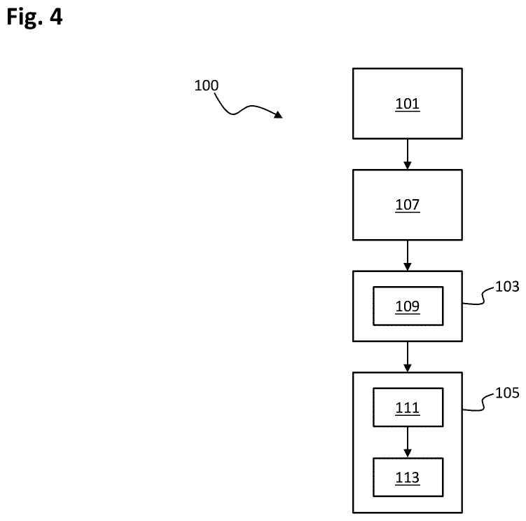

FIG. 4 shows a further flowchart of the method 100 for encrypting a source code 301 for use in a version control system 315 according to a further embodiment.

The embodiment in FIG. 4 is based on the embodiment in FIG. 3 and comprises all the process steps described there.

In a differing manner, in the embodiment shown, the individual lines 313 of the original source text 301 are split in a line separating step 107. This generates separate lines 307, which correspond to the respective lines 313 of the original source text 301 and are taken into account as individual objects.

In the embodiment shown, encryption is carried out line by line in the encrypting step 103.

For this purpose, each separated line 307 is encrypted in a line encrypting step 109 and a corresponding encrypted line 309 is generated for each separated line 307. The encrypted lines 309 are in turn taken into account as independent objects.

In the embodiment shown, the textualizing step 105 is also carried out line by line.

For this purpose, a textualization of each encrypted line 309 is carried out in a line textualizing step 111 and a corresponding textualized line representation 311 is generated for each encrypted line 309.

In a line merging step 113, the individual textualized line representations 311 are merged and combined into the textualized representation 305 of the encrypted source code version 303.

As already described above, the line order of the original source text 301 is retained, so that the textualized representation 305 represents an encoding of the original source text 301 in textual form, wherein the original structure of the original source text 301 is retained.

FIG. 5 shows a flowchart of the method 200 for decrypting a source code 301 according to an embodiment.

In order to decrypt a source text 301 encrypted according to the method 100 for encrypting a source text 301, a separation of the textualized line representations 311 of the textualized representation 305 of the encrypted source text version 303 is first carried out in a further line separating step 201.

In a de-textualizing step 203, the individual separated textualized line representations 311 are separately de-textualized and corresponding encoded lines 309, on the basis of which the textualized line representations 311 were originally generated by line-by-line textualization, are restored.

In a decrypting step 205, the individual encrypted lines 309 are decrypted line-by-line and the original separated lines 307, on the basis of which the encrypted lines 309 were generated by carrying out the line-by-line encryption, are restored.

Analogous to the encrypted textualization in procedure 100, the line orders of the individual representations or versions are retained during de-textualizing and decrypting.

In a further line merging step 207, the restored separated lines 307 are merged and combined in the restored original source text 301. As a result, the original source code 301, on the basis of which the corresponding textualized representation 305 of the encrypted source code version 303 was generated by carrying out the method 100 for encryption according to the application, is restored.

Due to the uniqueness of the encryption and textualization, the restored source text 301 corresponds to the original source text 301 without exception.

This invention has been described with respect to exemplary embodiments. It is understood that changes can be made and equivalents can be substituted to adapt these disclosures to different materials and situations, while remaining with the scope of the invention. The invention is thus not limited to the particular examples that are disclosed, but encompasses all the embodiments that fall within the scope of the claims.

TABLE 1
List of reference numerals

| | |
|---|---|
| 100 | method |
| 101 | provisioning step |
| 103 | encrypting step |
| 105 | textualizing step |
| 107 | line separating step |
| 109 | line encrypting step |
| 111 | line Textualizing step |
| 113 | line merging step |
| 200 | method |
| 201 | further line separating step |
| 203 | de-textualizing step |
| 205 | decrypting step |
| 207 | further line merging step |
| 300 | development system |
| 301 | source text |
| 302 | provisioning process |
| 303 | encrypted source code version |
| 304 | line separating process |
| 305 | textual representation |
| 306 | encrypting process |
| 307 | separated line |
| 308 | textualizing process |
| 309 | encrypted line |
| 310 | line merging process |
| 311 | textualized line display |
| 312 | storing process |
| 313 | line |
| 314 | charging process |
| 315 | version control system |
| 316 | further line separating process |
| 317 | automation system |
| 318 | de-textualizing process |
| 319 | controller |
| 320 | decrypting process |
| 321 | sensor/actuator unit |
| 322 | further line merging process |
| 323 | first key |
| 324 | installation process |
| 325 | second key |

1. A method of encrypting source code for use in a version control system, comprising:
providing the source code in an unencrypted and textual form in a provisioning step;
carrying out an encryption of the source code and generating an encrypted source code version in an encrypting step; and
carrying out a textualization of the encrypted source code version and generating a textualized representation of the encrypted source code version in a textualizing step, wherein encrypting and/or textualizing is carried out line by line, and wherein a line order of the unencrypted source text is maintained in the encrypted source text version and/or in the textualized representation of the encrypted source text version.

2. The method according to claim 1, further comprising:
carrying out a line separation of the source text and generating separated lines of the source text in a line separating step;
wherein the encrypting step is carried out on the separated lines of the source code and comprises for each separated line; and
carrying out an encryption of the separated line and generating an encrypted line of the encrypted source code version in a line encrypting step.

3. The method according to claim 2, wherein the textualizing step is carried out on the encrypted lines of the encrypted source text version and comprises for each encrypted line:
carrying out a textualization of the encrypted line of the encrypted source code version and generating a textualized line representation of the encrypted line of the encrypted source code version in a line textualizing step.

4. The method according to claim 3, wherein the textualizing step further comprises:
merging the plurality of textualized line representations of the encrypted lines of the encrypted source text version and generating the textual representation of the encrypted source text version as a whole of the textualized line representation in a line merging step.

5. The method according to claim 1, wherein the encryption is carried out as a decryptable encryption, and wherein by applying a corresponding key to the encrypted source text version, the encrypted source text version is unambiguously traceable back to the unencrypted source text.

6. The method according to claim 1, wherein the encryption is carried out as a symmetric encryption.

7. The method according to claim 1, wherein the encryption is carried out as an asymmetric encryption.

8. The method according to claim 1, wherein the textualization is carried out as a clearly reversible textualization, and wherein the textualized representation of the encrypted source text version is clearly convertible into the encrypted source text version by reversing the textualization in the form of a de-textualization.

9. The method according to claim 1, wherein the encryption is a unique encryption that results in the same encrypted lines for lines of the source text having the same content and in different encrypted lines for lines of the source text having different content, and/or wherein the textualization is a unique textualization which leads to the same textual line representation for encrypted lines having the same encryption and to different textual line representations of the encrypted lines for encrypted lines having different encryption.

10. The method according to claim 1, wherein the encryption is carried out as a binary encryption.

11. The method according to claim 1, wherein the textualization of the encrypted source code version is achieved by a base64 textualization algorithm.

12. The method according to claim 1, wherein the source code defines a control program for an automation system.

13. The method for decrypting a source text encrypted according to the method for encrypting a source text according to 1, comprising:
carrying out a line separation of the textualized representation of the encrypted source code version and generating separated textualized line representations of the encrypted lines of the encrypted source code version in a further line separating step;
carrying out a de-textualization of each textualized line representation of the encrypted lines of the encrypted source code version in a de-textualizing step;
carrying out a decryption of the encrypted lines of the encrypted source code version and generating unencrypted lines of the source code in a decrypting step; and
merging the unencrypted lines of the source text and generating a visible representation of the source text in a further line-merging step.

14. A development system for developing and/or editing a source code, wherein the development system comprising a computing unit having a processor and memory configured to carry out the method for encrypting a source code for use in a version control system according to claim 1.

15. A development system for developing and/or editing a source code, wherein the development system comprises a computing unit having a processor and memory configured to carry out the method for decrypting a source code according to claim 13.
